(19) United States
(12) Patent Application Publication
(10) Pub. No.: US 2007/0000399 A1
(43) Pub. Date: Jan. 4, 2007

(54) Printing apparatus and printing method

(75) Inventor: Shoji Kakimoto, Kyoto (JP)

Correspondence Address: MCDERMOTT WILL & EMERY LLP, 600 13TH STREET, N.W., WASHINGTON, DC, 20005-3096, US

(73) Assignee: DAINIPPON SCREEN MFG. CO., LTD.

(21) Appl. No.: 11/451,305

(22) Filed: Jun. 13, 2006

(30) Foreign Application Priority Data
Jun. 16, 2005 (JP) 2005-175850

(51) Int. Cl. B41F 13/24

(52) U.S. Cl. 101/232

(57) ABSTRACT

A printing apparatus includes a paper storage station, a paper feeder and an image pickup unit. The paper feeder has a sucker for sucking printing paper S, a conveyer belt for transporting the printing paper sucked by the sucker to a printing process, a plurality of rollers for assisting in transport of the printing paper S, support members for rotatably supporting the rollers, an overlap sensor for detecting any overlap of printing paper S transported by the conveyer belt, a register guide for adjusting the position of a forward end in a transport direction of the printing paper, and a pair of side guides for adjusting the position of the printing paper transversely thereof.

### BACKGROUND OF THE INVENTION

1. Field of the Invention

This invention relates to a printing apparatus and a printing method capable of adjusting positions transversely and in a transport direction of printing paper fed, based on the size of the printing paper.

2. Description of the Related Art

A known printing apparatus of the type noted above is described in Japanese Unexamined Patent Publication No. 2001-105573, for example. The apparatus described in this publication calculates a rigidity parameter based on paper data including the type, weight, dimensions, and texture of printing paper used, and presets adjustment items for a paper storage station, a printing station and a paper discharge station by using the rigidity parameter and paper data. This presetting operation is carried out by using a presetting table of preset amounts in the form of a database. Preset amounts corresponding to input values for the adjustment items are selected from the table, to apply preset values suited for required characteristics to the adjustment items.

Thus, the apparatus described in the above publication can preset, with high precision, the adjustment items for the paper storage station, printing station and paper discharge station by taking required paper characteristics for each adjustment item into account. This makes adjustment in time of actual printing operation unnecessary, and avoids a wasteful consumption of materials such as paper.

With the apparatus described in the above publication, however, the paper data including the type, weight, dimensions and texture of the paper to be used in printing must be made available beforehand.

Even though the paper data is obtained beforehand and a presetting is carried out for the paper storage station and so on based on this paper data, inconveniences may be encountered in certain cases. When, for example, different lots of paper are used in combination, though the sheets of paper are the same size, there can be a minute difference in size between the lots. The known apparatus cannot cope with such a size difference. Further, even the same lot, because of low cutting precision, may have minute size variations between sheets at the beginning of the lot and those at the end. The known apparatus cannot cope with such size variations, either.

### SUMMARY OF THE INVENTION

An object of this invention, therefore, is to provide a printing apparatus capable of adjusting, with high precision, the position of printing paper transported in time of feeding, without determining the size of the printing paper beforehand. Another object of this invention is to provide a printing apparatus capable of adjusting the position of printing paper transported, with high precision and in spite of minute variations in size.

The above objects are fulfilled, according to this invention, by a printing apparatus comprising an image pickup device including a line reader extending transversely of printing paper and having a reading range at least corresponding to a width of the printing paper, for obtaining an image of the printing paper; a computing device for determining a size of the printing paper based on the image of the printing paper obtained by the image pickup device; and a paper feed position adjusting device for adjusting, at a paper feeding time, positions transversely and in a transport direction of the printing paper transported, based on the size of the printing paper determined by the computing device.

This printing apparatus can adjust, with high precision, the position of the printing paper transported in time of paper feeding, without obtaining the size of the printing paper beforehand. Even when the size of the printing paper is changed during a printing operation, the position of the printing paper transported may be adjusted with high precision.

In one preferred embodiment, the printing apparatus further comprises a paper discharge position adjusting device for adjusting, at a paper discharging time, positions transversely and in the transport direction of the printing paper discharged to a paper discharge station, based on the size of the printing paper determined by the computing device.

With this construction, the position of the printing paper may be adjusted with high precision in time of paper discharge, by using the information for positional adjustment in time of paper feeding.

The paper discharge position adjusting device may include a pair of joggers movable transversely of the printing paper, and a drive source for driving the joggers.

This construction, simple as it is, can adjust the position of the printing paper with high precision in time of paper discharge.

In another aspect of the invention, a printing method is provided which comprises an image pickup step for obtaining an image of the printing paper with a line reader extending transversely of printing paper and having a reading range at least corresponding to a width of the printing paper; a computing step for determining a size of the printing paper based on the image of the printing paper obtained in the image pickup step; and a paper feed position adjusting step for adjusting, in time of subsequent paper feeding operation, positions transversely and in a transport direction of the printing paper transported, based on the size of the printing paper determined in the computing step.

Other features and advantages of the invention will be apparent from the following detailed description of the embodiments of the invention.

### BRIEF DESCRIPTION OF THE DRAWINGS

For the purpose of illustrating the invention, there are shown in the drawings several forms which are presently preferred, it being understood, however, that the invention is not limited to the precise arrangement and instrumentalities shown.

FIG. 1 is a schematic view of a printing apparatus according to this invention;

FIG. 2 is a schematic front view of a paper storage station;

FIG. 3 is a schematic side view of a paper feeder in the printing apparatus according to this invention;

FIG. 4 is a schematic plan view of the paper feeder;

FIG. 5 is a schematic plan view of a paper discharge station in the printing apparatus according to this invention; and

FIG. 6 is a block diagram showing a principal electrical structure of the printing apparatus according to this invention.

### DESCRIPTION OF THE PREFERRED EMBODIMENTS

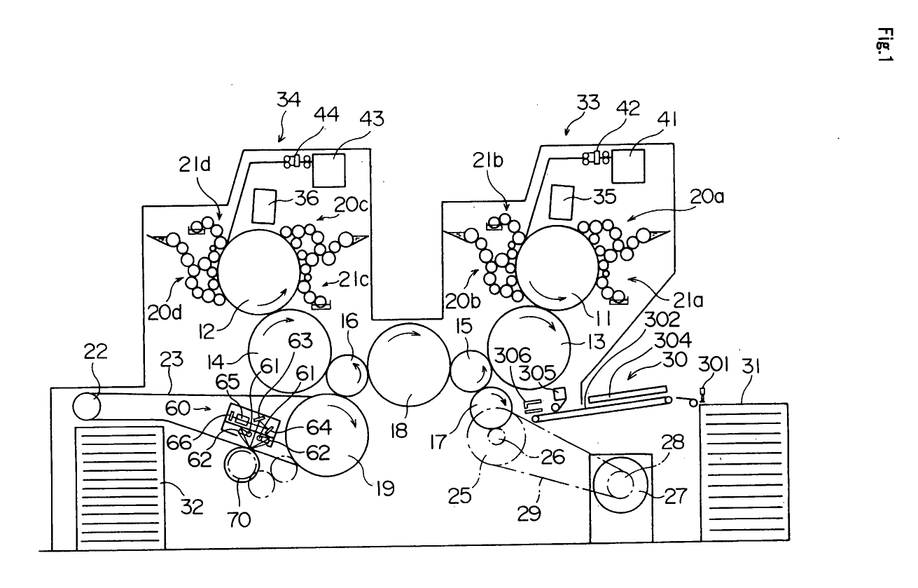

An embodiment of this invention will be described hereinafter with reference to the drawings. FIG. 1 is a schematic view of a printing apparatus according to this invention.

This printing apparatus records images on blank plates mounted on first and second plate cylinders 11 and 12 in a prepress process, feeds inks to the plates having the images recorded thereon, and transfers the inks from the plates through first and second blanket cylinders 13 and 14 to printing paper S held on first and second impression cylinders 15 and 16, thereby printing the images in four colors on the printing paper S.

The printing apparatus has the first plate cylinder 11, the second plate cylinder 12, the first blanket cylinder 13 contactable with the first plate cylinder 11, the second blanket cylinder 14 contactable with the second plate cylinder 12, the first impression cylinder 15 contactable with the first blanket cylinder 13, and the second impression cylinder 16 contactable with the second blanket cylinder 14. The printing apparatus further includes a paper feed cylinder 17 for transferring printing paper S supplied via a paper feeder 30 from a paper storage station 31 to the first impression cylinder 15, a transfer cylinder 18 for transferring the printing paper S from the first impression cylinder 15 to the second impression cylinder 16, a paper discharge cylinder 19 with chains 23 wound thereon and extending to and wound on sprockets 22 for discharging printed paper S from the second impression cylinder 16 to a paper discharge station 32, and an image pickup station 60 for reading images and measuring densities of detecting patches printed on the printing paper S. The image pickup station 60 is used to obtain binary images for determining sizes of the printing paper, and density data for controlling ink feed rates.

Each of the first and second plate cylinders 11 and 12 is what is called a two-segmented cylinder for holding two printing plates peripherally thereof for printing in two different colors. The first and second blanket cylinders 13 and 14 have the same diameter as the first and second plate cylinders 11 and 12, and each has blanket surfaces for transferring images in two colors.

The first and second impression cylinders 15 and 16 movable into contact with the first and second blanket cylinders 13 and 14, respectively, have half the diameter of the first and second plate cylinders 11 and 12 and the first and second blanket cylinders 13 and 14. The first and second impression cylinders 15 and 16 have grippers, not shown, for holding and transporting the forward end of printing paper S.

The paper feed cylinder 17 disposed adjacent the impression cylinder 15 has the same diameter as the first and second impression cylinders 15 and 16. The paper feed cylinder 17 has a gripper for holding and transporting, with each intermittent rotation of the feed cylinder 17, the forward end of each sheet of printing paper S fed from the paper storage station 31. When the printing paper S is transferred from the feed cylinder 17 to the first impression cylinder 15, the gripper of the first impression cylinder 15 holds the forward end of the printing paper S which has been held by the gripper of the feed cylinder 17.

The transfer cylinder 18 disposed between the first impression cylinder 15 and second impression cylinder 16 has the same diameter as the first and second plate cylinders 11 and 12 and the first and second blanket cylinders 13 and 14. The transfer cylinder 18 has a gripper, not shown, for holding and transporting the forward end of the printing paper S received from the first impression cylinder 15, and transferring the forward end of the printing paper S to the gripper of the second impression cylinder 16.

The paper discharge cylinder 19 disposed adjacent the second impression cylinder 16 has the same diameter as the first and second plate cylinders 11 and 12 and the first and second blanket cylinders 13 and 14. The discharge cylinder 19 has a pair of chains 23 wound around opposite ends thereof. The chains 23 are interconnected by coupling members, not shown, having a plurality of grippers, not shown, arranged thereon. When the second impression cylinder 16 transfers the printing paper S to the discharge cylinder 19, one of the grippers on the discharge cylinder 17 holds the forward end of the printing paper S having been held by the gripper of the second impression cylinder 16. With movement of the chains 23, the printing paper S is transported to the paper discharge station 32 to be discharged thereon.

The paper feed cylinder 17 has a gear attached to an end thereof and connected to a gear 26 disposed coaxially with a driven pulley 25. A belt 29 is wound around and extends between the driven pulley 25 and a drive pulley 28 rotatable by a motor 27. Thus, the paper feed cylinder 17 is rotatable by drive of the motor 27. The first and second impression cylinders 15 and 16, paper feed cylinder 17, transfer cylinder 18 and paper discharge cylinder 19 are coupled to one another by gears attached to ends thereof, respectively. Thus, by the drive of motor 27, the paper feed cylinder 17, first and second impression cylinders 15 and 16, paper discharge cylinder 19, first and second blanket cylinders 13 and 14, first and second plate cylinders 11 and 12 and transfer cylinder 18 are rotatable synchronously with one another.

The first plate cylinder 11 is surrounded by an ink feeder 20a for feeding an ink of black (K), for example, to a plate, an ink feeder 20b for feeding an ink of cyan (C), for example, to a plate, and dampening water feeders 21a and 21b for feeding dampening water to the plates. The second plate cylinder 12 is surrounded by an ink feeder 20c for feeding an ink of magenta (M), for example, to a plate, an ink feeder 20d for feeding an ink of yellow (Y), for example, to a plate, and dampening water feeders 21c and 21d for feeding dampening water to the plates.

Further, arranged around the first and second plate cylinders 11 and 12 are a plate feeder 33 for feeding plates to the peripheral surface of the first plate cylinder 11, a plate feeder 34 for feeding plates to the peripheral surface of the second plate cylinder 12, an image recorder 35 for recording images on the plates mounted peripherally of the first plate cylinder 11, and an image recorder 36 for recording images on the plates mounted peripherally of the second plate cylinder 12.

The image pickup station 60 includes a pair of linear light sources 61 extending parallel to a suction roller 70 for illuminating the printing paper on the suction roller 70, a pair of condensing plates 62, reflecting mirrors 63 and 64, a condensing lens 65 and a CCD line sensor 66 acting as a line reader. The printing paper transported by the paper discharge mechanism including the paper discharge cylinder 19 and chains 23 is illuminated by the pair of linear light sources 61, and photographed by the CCD line sensor 66. The image of the printing paper and density data are displayed on a control panel of the touch panel type not shown. This CCD line sensor 66 is installed to extend transversely of printing paper S, and covers a range at least corresponding to the width of printing paper S. The CCD line sensor 66 has a construction for scanning transversely of printing paper S. Thus, by micrifying sweep spacing, highly precise images can be obtained in the longitudinal direction of printing paper S.

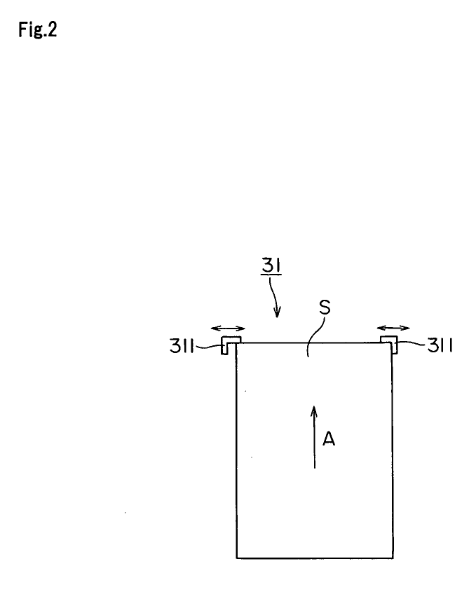

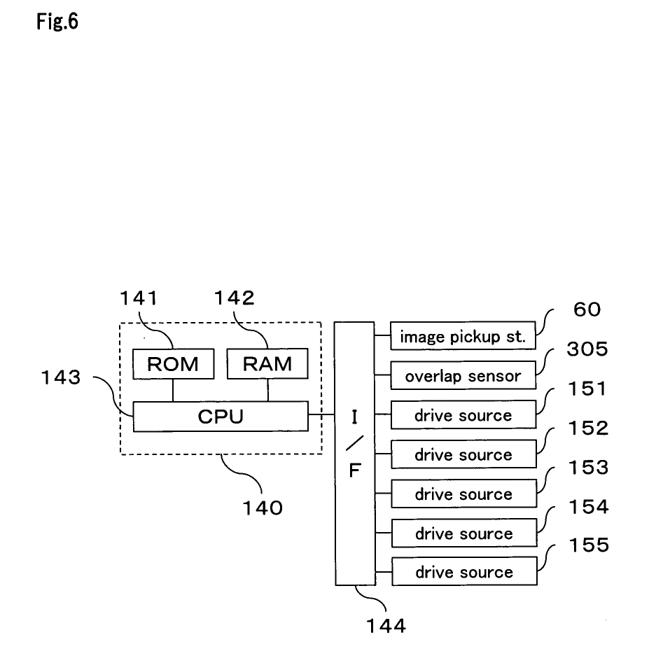

FIG. 2 is a schematic front view of the paper storage station 31. The paper storage station 31 has a pair of vertical guides 311 for roughly adjusting printing paper S loaded therein, in directions transversely of the printing paper S. The vertical guides 311 are movable back and forth transversely of printing paper S by drive of a drive source 151 such as a motor (FIG. 6). The vertical guides 311 are moved transversely of printing paper S based on the size of printing paper S calculated by a computing device to be described hereinafter. It is thus possible to adjust roughly the position of printing paper S before feeding it to the paper feeder 30.

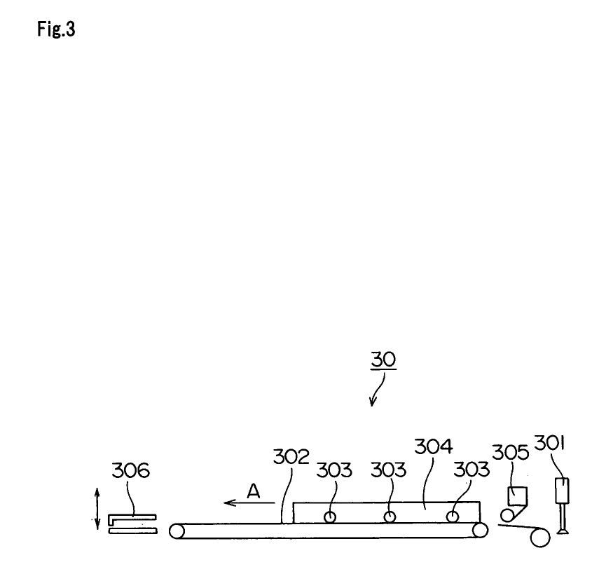

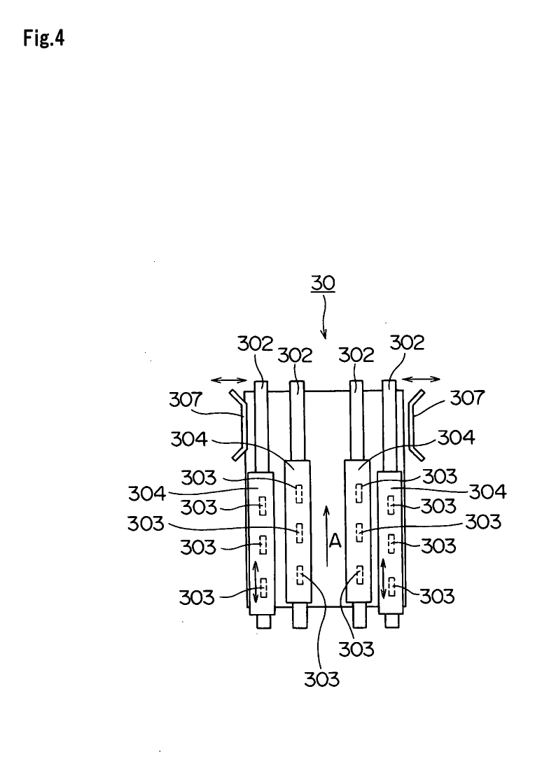

FIG. 3 is a schematic side view of the paper feeder 30 n the printing apparatus according to this invention. FIG. 4 is a schematic plan view of the paper feeder 30.

The paper feeder 30 includes a sucker 301 for sucking an uppermost sheet of printing paper S from the paper storage station 31, conveyer belts 302 for transporting the sheet of printing paper S sucked by the sucker 301 toward the paper feed cylinder 17, a plurality of rollers 303 arranged opposite the conveyer belts 302 for assisting in transport of the printing paper S, support members 304 for rotatably supporting the rollers 303, an overlap sensor 305 for detecting any overlap of printing paper S transported by the conveyer belts 302, a register guide 306 for adjusting the position of a forward end in a transport direction (i.e. a direction of arrow A) of the printing paper S, and a pair of side guides 307 for adjusting the position of the printing paper S transversely thereof.

Four conveyer belts 302 are juxtaposed transversely of the printing paper S. Each of the four conveyer belts 302 is movable transversely of the printing paper S. By moving the conveyer belts 302, varied sizes of printing paper S can be accommodated for transport.

Four support members 304 are arranged in positions opposed to the four conveyer belts 302, respectively. Each of the four support members 304 rotatably supports three rollers 303. Of the four support members 304, two inner support members 304 are arranged movable transversely of the printing paper S. The two outer support members 304 are arranged movable in the transport direction (i.e. the direction of arrow A) of the printing paper S. By moving the support members 304, varied sizes of printing paper S can be accommodated for transport. The above-noted numbers of conveyer belts 302, rollers 303 and so on are not limitative, but any suitable numbers of these components may be provided.

The overlap sensor 305 has a construction for mechanically detecting a paper thickness, and is a microswitch or pressure sensor, for example. Alternatively, an ultrasonic sensor may be employed as the overlap sensor 305.

The register guide 306 serves to adjust the position of a forward end in the transport direction (i.e. the direction of arrow A) of the printing paper S. The register guide 306 is movable up and down by drive of a drive source 152 such as a motor (FIG. 6). Thus, the register guide 306 presents no obstruction to the transport of printing paper S to the paper feed cylinder 17 constituting the subsequent stage of transport.

The pair of side guides 308 are movable back and forth transversely of the printing paper S by drive of a drive sources 153 such as a motor (FIG. 6). The side guides 308 are movable transversely of the printing paper S based on a size of the printing paper S calculated by the computing device described hereinafter. It is thus possible to adjust the position of the printing paper S transversely thereof.

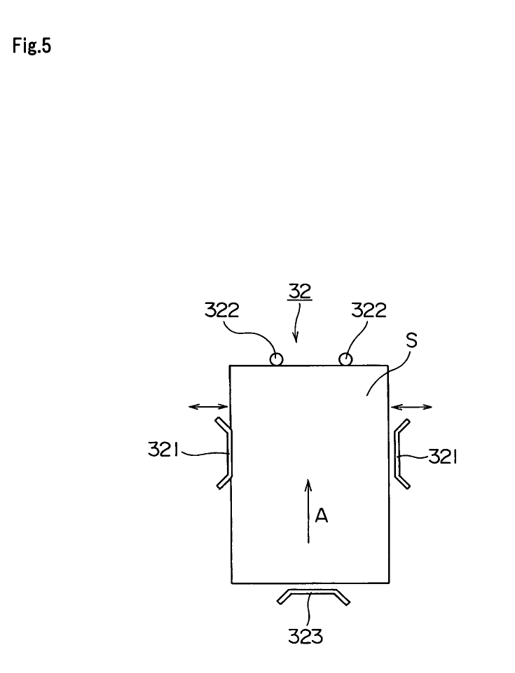

FIG. 5 is a schematic plan view of the paper discharge station 32 in the printing apparatus according to this invention.

The paper discharge station 32 is provided for receiving discharged sheets of printing paper S. The paper discharge station 32 includes a pair of joggers 321 for transversely adjusting the position of the printing paper S discharged, stoppers 322 for adjusting the position of the forward end in a discharge direction (i.e. a direction of arrow A) of the printing paper S, and a rear jogger 323 for pressing a rear end in the discharge direction (i.e. the direction of arrow A) of the printing paper S until the forward end thereof contacts the stoppers 322.

The pair of joggers 321 are movable transversely of the printing paper S, and are connected to a drive source 154 (FIG. 6). The joggers 321 are movable transversely of the printing paper S based on the size of the printing paper S calculated by the computing device described hereinafter. It is thus possible to adjust the position of the printing paper S transversely thereof.

The rear jogger 323 is movable in the longitudinal direction of the printing paper S, and is connected to a drive source 155 (FIG. 6). The rear jogger 323 is movable in the longitudinal direction of the printing paper S based on the size of the printing paper S calculated by the computing device described hereinafter. It is thus possible to adjust the position in the longitudinal direction of the printing paper S.

FIG. 6 is a block diagram showing a principal electrical structure of the printing apparatus according to this invention.

This printing apparatus includes a control unit 140 having a ROM 141 for storing operating programs necessary for controlling the apparatus, a RAM 142 for temporarily storing data during a control operation, and a CPU 143 for performing logic operations.

The control unit 140 has, connected thereto through an interface 144, the image pickup station 60, overlap sensor 305, drive source 151 of the vertical guides 311, drive source 152 of the register guide 306, drive source 153 of the side guides 307, drive source 154 of the joggers 321, and drive source 155 of the rear jogger 323. The control unit 140 has also a driving circuit connected thereto for generating driving signals for driving the ink feeders 20, dampening water feeders 21, image recorders 35 and 36, the contact mechanisms for the first and second blanket cylinders 13 and 14, and so on.

The printing apparatus having the above construction first transports printing paper S from the paper storage station 31 to the image pickup station 60 without printing an image on the paper S. At this time, a rough positional adjustment may be carried out manually for the paper storage station 31, for example. An image of the printing paper S (hereinafter called paper image) obtained from the image pickup station 60 is binarized, and the width and length of the printing paper S are calculated. The binarization herein refers to a method for determining brightness of each pixel in the paper image obtained from the image pickup station 60, and outputting white when the brightness exceeds a certain fixed value, and black when it does not. Since all halftone portions are classified into white or black, the resulting paper image shows the shape of the paper.

The CPU 143 compares the width and length of printing paper S obtained in this way with information on printing paper stored in the ROM 141. As a result, a size of the printing paper is determined. By calculating the width and length of printing paper S as above, an optimal size of the printing paper S is determined even when the printing paper S is transported in an inclined state.

The information on printing paper stored in the ROM 141 includes sizes of printing paper, values to be acquired from the overlap sensor 305 corresponding to the printing paper (corresponding to paper thickness), driving ranges of the vertical guides 311, driving ranges of the side guides 307, driving ranges of the joggers 321, and driving ranges of the rear jogger 323. Since the size of printing paper S is derived from the paper image obtained by the image pickup station 60 as described above, the position of the printing paper S is adjusted with high precision by using the information on the size of the printing paper S. In the foregoing example, a printing paper size stored beforehand is obtained from the calculated printing paper size. For the width and length of the printing paper, the values derived from the calculation may be used as they are.

After the information on the printing paper is obtained, a printing plate stock drawn from a supply cassette 41 of the plate feeder 33 is cut to a predetermined size by a cutter 42. The forward end of each plate in cut sheet form is guided by guide rollers and guide members, not shown, and is clamped by clamps of the first plate cylinder 11. Then, the first plate cylinder 11 is driven by a motor, not shown, to rotate at low speed, whereby the plate is wrapped around the peripheral surface of the first plate cylinder 11. The rear end of the plate is clamped by other clamps of the first plate cylinder 11. While, in this state, the first plate cylinder 11 is rotated at low speed, the image recorder 35 irradiates the surface of the plate mounted peripherally of the first plate cylinder 11 with a modulated laser beam for recording an image thereon.

Similarly, a printing plate stock drawn from a supply cassette 43 of the plate feeder 34 is cut to the predetermined size by a cutter 44. The forward end of each plate in cut sheet form is guided by guide rollers and guide members, not shown, and is clamped by clamps of the second plate cylinder 12. Then, the second plate cylinder 12 is driven by a motor, not shown, to rotate at low speed, whereby the plate is wrapped around the peripheral surface of the second plate cylinder 12. The rear end of the plate is clamped by other clamps of the second plate cylinder 12. While, in this state, the second plate cylinder 12 is rotated at low speed, the image recorder 36 irradiates the surface of the plate mounted peripherally of the second plate cylinder 12 with a modulated laser beam for recording an image thereon.

The first plate cylinder 11 has, mounted peripherally thereof, a plate for printing in black ink and a plate for printing in cyan ink. The two plates are arranged in evenly separated positions (i.e. in positions separated from each other by 180 degrees). The image recorder 35 records images on these plates. Similarly, the second plate cylinder 12 has, mounted peripherally thereof, a plate for printing in magenta ink and a plate for printing in yellow ink. The two plates also are arranged in evenly separated positions, and the image recorder 36 records images on these plates, to complete a prepress process.

The above prepress process and the process of setting a printing paper size may be carried out in a reversed order, or may be carried out in parallel.

The prepress process is followed by a printing process for printing the printing paper with the plates mounted on the first and second plate cylinders 11 and 12. This printing process is carried out as follows.

First, each dampening water feeder 21 and each ink feeder 20 are placed in contact with only a corresponding one of the plates mounted on the first and second plate cylinders 11 and 12. Consequently, dampening water and inks are fed to the plates from the corresponding water feeders 21 and ink feeders 20, respectively. These inks are transferred from the plates to the corresponding regions of the first and second blanket cylinders 13 and 14, respectively.

Then, the printing paper S is fed from the paper storage station 31 through the paper feeder 30 to the paper feed cylinder 17. At this time, the position of the printing paper S is adjusted transversely thereof on the paper feeder 30 by the side guides 307 driven based on the information on the printing paper. The printing paper S is passed from the paper feed cylinder 17 to the first impression cylinder 15. The impression cylinder 15 having received the printing paper continues to rotate. Since the first impression cylinder 15 has half the diameter of the first plate cylinder 11 and the first blanket cylinder 13, the black ink is transferred to the printing paper S wrapped around the first impression cylinder 15 in its first rotation, and the cyan ink in its second rotation.

After the first impression cylinder 15 makes two rotations, the printing paper S is passed from the first impression cylinder 15 to the second impression cylinder 16 through the transfer cylinder 18. The second impression cylinder 16 having received the printing paper continues to rotate. Since the second impression cylinder 16 has half the diameter of the second plate cylinder 12 and the second blanket cylinder 14, the magenta ink is transferred to the printing paper S wrapped around the second impression cylinder 16 in its first rotation, and the yellow ink in its second rotation.

The printing paper S printed in the four colors in this way is transported by the pair of chains 23 toward the paper discharge station 32 to be discharged thereon. At this time, the printing paper being transported is illuminated by the pair of linear light sources 61, and is photographed by the CCD line sensor 66. The photographed image is displayed on the control panel not shown.

Then, the CPU 143 calculates a relationship between the position of the printing paper S and the position of the image printed on the printing paper S from the images (i.e. the paper image and the image on the printing paper) read at the image pickup station 60. In this operation, for example, a mark for position detection is applied to the center of the image printed, and an amount of displacement between the center of printing paper S and the mark for position detection is calculated. When the amount of displacement is not zero, changes are made to the positions of the vertical guides 311 and side guides 307 and to the position of the joggers 321 of the paper discharge station 32 to reduce the amount of displacement to zero. In this way, the position of the printing paper S is adjusted transversely thereof so that the printed image may be located at the middle transversely of the printing paper S. The above construction, simple as it is, can adjust the position of the printed image on the printing paper S without requiring such major corrections as changing positions of the printing plates and positions of the images recorded on the printing plates.

When a change in the size of the printing paper is detected from the paper image, the adjustment value for each component of the above paper storage station 31 may be varied during a printing operation. For example, the driving range of the side guides 307 or the like is varied in real time in response to the size of the printing paper. Consequently, the paper storage station 31 may be adjusted accurately even when minute changes take place in the size of the printing paper.

In the embodiment described above, only the paper storage station 31 and the joggers 321 of the paper discharge station 32 are adjusted. The results of detecting the size of the printing paper may be used for adjusting other components related to the size of the printing paper. Where, for example, a brake wheel is provided, whose position is variable by a motor or the like, for braking the printing paper discharged to the paper discharge station 32, the position of the brake wheel may be adjusted based on the results of detecting the size of the printing paper.

This invention may be embodied in other specific forms without departing from the spirit or essential attributes thereof and, accordingly, reference should be made to the appended claims, rather than to the foregoing specification, as indicating the scope of the invention.

This application claims priority benefit under 35 U.S.C. Section 119 of Japanese Patent Application No. 2005-175850 filed in the Japanese Patent Office on Jun. 16, 2005, the entire disclosure of which is incorporated herein by reference.

What is claimed is:

1. A printing apparatus comprising:
an image pickup device including a line reader extending transversely of printing paper and having a reading range at least corresponding to an width of the printing paper, for obtaining an image of the printing paper;
a computing device for determining a size of the printing paper based on the image of the printing paper obtained by said image pickup device; and
a paper feed position adjusting device for adjusting, at a paper feeding time, positions transversely and in a transport direction of the printing paper transported, based on the size of the printing paper determined by said computing device.

2. A printing apparatus as defined in claim 1, wherein said computing device is arranged to determine the size of the printing paper by binarizing the image of the printing paper obtained by said image pickup device, and calculating the width and a length of the printing paper.

3. A printing apparatus as defined in claim 2, wherein said paper feed position adjusting device includes a pair of side guides movable transversely of the printing paper, and a drive source for driving said side guides.

4. A printing apparatus as defined in claim 2, further comprising a paper discharge position adjusting device for adjusting, at a paper discharging time, positions transversely and in the transport direction of the printing paper discharged to a paper discharge station, based on the size of the printing paper determined by said computing device.

5. A printing apparatus as defined in claim 4, wherein said paper discharge position adjusting device includes a pair of joggers movable transversely of the printing paper, and a drive source for driving said joggers.

6. A printing apparatus as defined in claim 1, wherein said paper feed position adjusting device is arranged to adjust the position of the printing paper transversely thereof, based on a printed image on the printing paper obtained by said image pickup device, so that the printed image is located at a middle transversely of the printing paper.

7. A printing apparatus as defined in claim 6, wherein said paper feed position adjusting device is arranged to adjust the position of the printing paper transversely thereof, based on the printed image on the printing paper obtained by said image pickup device, and by calculating distances between the printed image and edges of the printing paper, so that the printed image is located at a middle transversely of the printing paper.

8. A printing apparatus as defined in claim 1, wherein said image pickup device is arranged also to measure density data for controlling an ink feeding rate.

9. A printing apparatus as defined in claim 1, wherein:
said image pickup device is arranged to photograph the printing paper continuously during a printing operation; and
when the size of the printing paper determined by said computing device varies during the printing operation, said paper feed position adjusting device adjusts the positions transversely and in the transport direction of the printing paper again.

10. A printing method comprising:
an image pickup step for obtaining an image of the printing paper with a line reader extending transversely of printing paper and having a reading range at least corresponding to a width of the printing paper;
a computing step for determining a size of the printing paper based on the image of the printing paper obtained in said image pickup step; and
a paper feed position adjusting step for adjusting, in time of subsequent paper feeding operation, positions transversely and in a transport direction of the printing paper transported, based on the size of the printing paper determined in said computing step.

11. A printing method as defined in claim 10, wherein said computing step is executed to determine the size of the printing paper by binarizing the image of the printing paper obtained in said image pickup step, and calculating the width and a length of the printing paper.

12. A printing method as defined in claim 11, wherein said paper feed position adjusting step is executed to adjust the positions by using a pair of side guides movable transversely of the printing paper, and a drive source for driving said side guides.

13. A printing method as defined in claim 11, further comprising a paper discharge position adjusting step for adjusting, at a paper discharging time, positions transversely and in the transport direction of the printing paper discharged to a paper discharge station, based on the size of the printing paper determined in said computing step.

14. A printing method as defined in claim 13, wherein said paper discharge position adjusting step is executed to adjust the positions by using a pair of joggers movable transversely of the printing paper, and a drive source for driving said joggers.

15. A printing method as defined in claim 10, wherein said paper feed position adjusting step is executed to adjust the position of the printing paper transversely thereof, based on a printed image on the printing paper obtained in said image pickup step, so that the printed image is located at a middle transversely of the printing paper.

16. A printing method as defined in claim 15, wherein said paper feed position adjusting step is executed to adjust the position of the printing paper transversely thereof, based on the printed image on the printing paper obtained in said image pickup step, and by calculating distances between the printed image and edges of the printing paper, so that the printed image is located at a middle transversely of the printing paper.

17. A printing method as defined in claim 10, wherein:
said image pickup device and said computing step are executed continuously during a printing operation; and
when the size of the printing paper varies during the printing operation, the positions transversely and in the transport direction of the printing paper transported are adjusted in time of subsequent paper feeding.
